(19) United States
(12) Patent Application Publication
(10) Pub. No.: US 2006/0100934 A1
(43) Pub. Date: May 11, 2006

(54) Automated customer interface and ordering system for requisitioning the manufacture of customized equipment and products

(76) Inventors: Janice Burr, Wilmington, NC (US); Mike Elliott, Roanoke, VA (US); Hannah E. Gloria, Roanoke, VA (US); George G. Matzko, Roanoke, VA (US); Chandrashekar Rachakonda, Hyderabad (IN); John R. Walton, Roanoke, VA (US)

Correspondence Address: NIXON & VANDERHYE, PC, 901 NORTH GLEBE ROAD, 11TH FLOOR, ARLINGTON, VA, 22203, US

(21) Appl. No.: 10/985,007

(22) Filed: Nov. 10, 2004

(51) Int. Cl. G06Q 30/00

(52) U.S. Cl. 705/26

(57) ABSTRACT

A computer implemented method and system for automating the process of creating and placing customized manufacturing orders for complex electronic equipment and housing assemblies. In one non-limiting example implementation, a computerized customer ordering interface is provided for aiding a requisition engineer in designing and requisitioning the manufacture of customized cabinet/rack-mounted housing and wiring arrangements for complex industrial electronic equipment.

### BACKGROUND OF THE INVENTION

Conventional approaches and procedures for designing and ordering the manufacture of custom electronic control equipment for industrial applications to meet the special needs of a particular industrial consumer often entails weeks of design and requisition work. Industrial electronic equipment configuration, housing and installation arrangements may involve many diverse components and entail the use of sophisticated cabinet/rack-mounted housing arrangements with complex wiring arrangements. Typically, weeks of labor may be expended just in the creating and modifying of 3D models of cabinet and wiring configurations for the housing arrangements for a single controller. Additional weeks of labor may be spend developing various factory assembly documents including compiling a comprehensive bill of materials required for the assembly and verifying that the specific requests and requirements of a particular customer are met. Consequently, there is a need for a more efficient customer interface and ordering system for designing and requisitioning the manufacture of customized equipment housing assemblies for industrial applications/installations that simplifies the design and ordering process and significantly reduces the total number of man-hours ordinarily needed to perform such tasks.

### BRIEF DESCRIPTION OF THE INVENTION

A computerized ordering system and customer interface is provided for placing orders for customized equipment and products. In a non-limiting exemplary implementation disclosed herein, a computerized ordering system simplifies the process of designing and requisitioning custom cabinet/rack-mounted housing and wiring arrangements for complex industrial electronic controller equipment such as used, for example, for controlling a turbine power generator system. One beneficial aspect of the exemplary computer implemented process and system disclosed herein is that it provides a user interface that is easy to use and which significantly reduces the amount of time required by a requisition engineer to develop and process an order. A further beneficial aspect of the exemplary system disclosed herein is its ability to produce detailed job-specific documentation such as, for example, factory assembly documentation, a bill of materials, electrical cable labels, wiring report documents and the like.

### BRIEF DESCRIPTION OF THE DRAWINGS

These and other features and advantages of the present invention will be better appreciated by reading the following detailed description of the invention in conjunction with the accompanying FIGURES:

FIG. 1 is a process diagram illustrating an overview of exemplary user interface tools and computer server implemented processes for designing and ordering the manufacture of custom cabinet/housing arrangements for electronic equipment;

FIG. 2 is a flowchart depicting an example computer implemented process for processing job orders for requisitioning the manufacture of customized electronic equipment;

FIG. 3 is a schematic diagram of an general purpose computer system and network in which an interactive user interface ordering tool for requisitioning the manufacture of customized electronic equipment cabinets/housings operates;

FIG. 4 is an architectural diagram of an example arrangement of a system for implementing the interactive user interface requisitioning tool on a network; and

FIGS. 5 through 39 illustrate example graphic representations of interactive user interface tools displayed by automated customer interface and ordering system on a user computer device.

### DETAILED DESCRIPTION OF THE INVENTION

In the following description specific details are set forth for purposes of explanation only, and not limitation, with respect to a customer interface and computerized system for ordering customized electronic equipment housings and wiring arrangements. The exemplary implementation disclosed herein is not limited to the specific example illustrated in the FIGURES described above. Moreover, it will be apparent to one skilled in the art that the non-limiting example implementations disclosed herein may be practiced in other embodiments that depart from these specific details.

The non-limiting exemplary implementation described herein provides a computerized tool for requisitioning custom cabinet/rack-mounted housing and wiring arrangements for complex electronic equipment. The complex electronic equipment may be a product such as a gas turbine power generation system controller or an industrial process machine controller or the like, however, this disclosure is applicable to any system where it is desirable to efficiently specify components and requisition the manufacture of industrial electronic equipment housings.

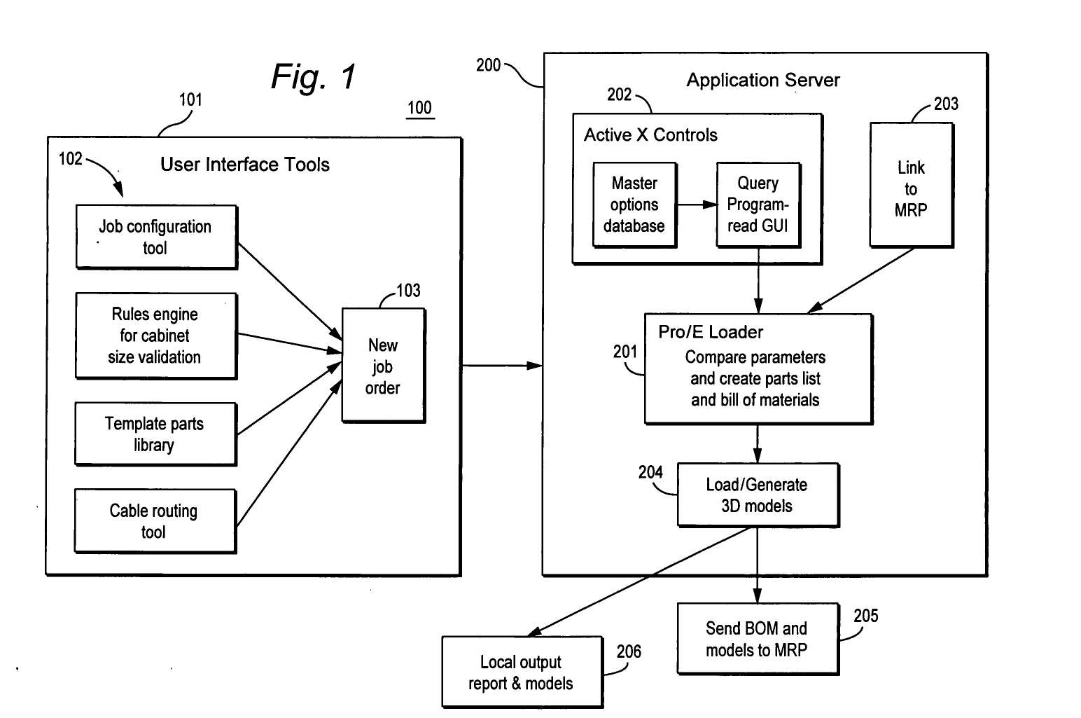

FIG. 1 shows a high level process diagram illustrating an overview of an exemplary ordering system 100 for requisitioning the manufacture of customized equipment and products. An interactive graphic user interface (GUI) 101 comprises a set of interactive software tools 102 implemented on a computer that is used to create and configure a manufacturing “job order” or manufacturing requisition proposal (MRPs). A server 200 coupled to the computer via the Internet or other suitable digital communications link receives the job order from the computer and generates a set of engineering drawings and associated documentation that is sent to a manufacturer to make the particular piece of equipment in accordance with the order. Interactive user interface 101 is able to determine whether a particular manufacturing job request can actually be performed based on already existing equipment specifications or whether there is a need for further design work. In addition, interactive user interface 101 also permits the user a significant degree of variability in the design of a particular cabinet/housing arrangement within at least certain predefined limits based on the particular electronic equipment or system specification. Applications server 200 responds to job orders 103 created by a user and implements software processes that result in producing drawings and other documentation ordinarily required by a manufacturer for filling a order for the manufacture of customized equipment. Applications server 200 may comprise one or more conventional network server computers or a conventional computer system configured as a server in a client/server computing context for responding to one or more client computer processing requests.

In the non-limiting example disclosed herein, ordering system 100 comprises an interactive graphic user interface 101, used to create manufacturing job orders (i.e., Manufacturing Requisition Proposals) for cabinets/housings for electronic controller equipment, and an application server 200 which is used to generate documentation for the customer (i.e., the user) and/or for the manufacturer regarding the job order. For example, based on information in a job order produced by graphic user interface 101, server 200 provides MRP bills of material (BOMs), drawings for the customer, factory assembly drawings for the manufacturer, and determines electric cable run lengths and prints associated cable/wiring labels. In this context, the graphic user interface 101 acts as a contact point providing a plurality of useful software tools 102 for creating and tailoring a particular manufacturing job order or MRP. Through an interactive presentation of a plurality of display windows having graphic “buttons”, icons, and text input boxes, the graphic user interface 101 allows a user to specify and customize the component contents, size and layout for a cabinet/rack-mounted housing for electronic controller equipment.

A few non-limiting examples of the various user interface tools 102 which may make up interactive user interface 100 are described below with reference to FIG. 1: a rules engine for cabinet/housing size validation, a cable routing tool, a library of template parts, and a job configuration screen. These “tools” may each take the form of individual software components or modules that work together, or alternatively, interactive graphic user interface 100 may be implemented as a solitary integral software component comprising interactive ordering options/features.

In a non-limiting exemplary embodiment disclosed herein, the interactive “tools”/features of graphic user interface 100 are implemented through the use of one or more interactive graphic windows having text input boxes and graphic illustration portions that are displayed on the screen of a user's computer display device. A software programmer of ordinary skill in the art would appreciate that the interactive graphic windows for displaying “tools”/features of graphic user interface 100 could be implemented, for example, using conventional C++ and/or Java™ programming techniques or the like without undue experimentation. Moreover, one of ordinary skill in the art would appreciate that different and customized software features or “tools” (102) may be included as part of user interface 101, as when it is used for particular or specific technical/industrial applications, and that the invention is not intended as being limited solely to automating the ordering process of cabinet/rack-mounted housings or to the specific exemplary user interface tools disclosed herein below:

Job Configuration Tool

A job order or “job” is a collection of “templates” that a user has selected based on their particular application requirements. The user interface allows the templates to be inserted in a “drag and drop” fashion into a “job screen” display window (which may be one of a plurality of the different display windows generated by user interface 101 for display on the user's computer display device). That job is then stored on the user computer's hard drive to be ready to be released (sent) to the remote server 200 for further processing as described below.

Templates Library

The template parts library is a collection of components that are valid existing parts that can be added to a job. For this example, three categories of templates are used: connects, components and enclosures. All the options that are available to the user in the template library are pre-populated by a super-user. This arrangement allows a user to select from available components to create a custom configured job.

Cable Routing Tool

The cable routing tool allows a user to graphically “link” the components configured into a job. It then calculates the length of that cable path and lets the user search against a library of parts to either select an existing part or create a new part number for that length. The cable routing tool also generates a report of the cable part numbers and the items they connect.

Cabinet Size Validation Tool

A cabinet/housing size is validated through a section of code called a “rules engine”. This software tool returns an answer to the question of whether the user's equipment requirements can be accommodated using existing stock cabinet/housing designs (i.e., whether the amount of I/O cards/equipment slots that the user has requested to use will actually fit within the particular size cabinet/housing that the user has selected. Using this tool allows the user to come to a compromise on cabinet size verses columns of I/O cards.

Once a job order is created by using the user interface tools 102, the user “releases” the job to the next stage of processing by sending it to the MRP application server 200. A file 103 containing the job information, such as a Microsoft Access Database (MDB) file, is created by user interface 101 and then forwarded to server 200. This may be implemented at the user interface 101 by a “release” button (not shown) that is displayed, for example, in a Windows® screen display or in a drop-down menu or tool bar provided by user interface 101 on the user's computer display. Such a button can be made to activate, for example, an ActiveX DLL that incorporates Microsoft's INET control and the file is then FTP'd to file server 200. In this example, new job order file 103 is sent to an MRP applications server computer 200 that is either part of the same network as the user's computer or is connected to the user's computer via the Internet or some other feasible digital communications link.

MRP applications server 200 runs one or more suitable CAD/CAM type applications 210, such as “Pro/E”. (Pro-Engineer™—a relatively well known and readily commercially available software package for 3-D CAD/CAM applications.) A conventional loader process, available either as part of the Pro/E™ application package or other common CAD/CAM software, recognizes and uses ActiveX DLLs to load and read parameters from the released job file 103. The parameters and options provided in a user's job order generated by graphic user interface 101 are placed in job order file 103 and used by server 200 to create customer and manufacturing documentation such as engineering drawings, a parts list, a bill of materials (BOM), and the like. Moreover, server 200 may also use this information to perform comparisons with a one or more manufacturer's stock/inventory information and parts/products specifications for providing immediate feedback or other reports to the user concerning potential incompatibilities or unavailability of particular components.

Based on information and parameters provided in job file 103, a Pro/E™ program or other CAD/CAM type application running on server 200 can also generate 2-D and 3-D model drawings (204) of a proposed manufactured product for use by the manufacturer and/or the customer (i.e., the user). The generated model drawings, a bill of materials and other documentation may then be sent directly to a manufacturer (205) via server 200. In addition, server 200 can also provide output documentation such as reports and model drawings locally (206) and/or provide any generated documentation back to the particular user computer that generated the job order.

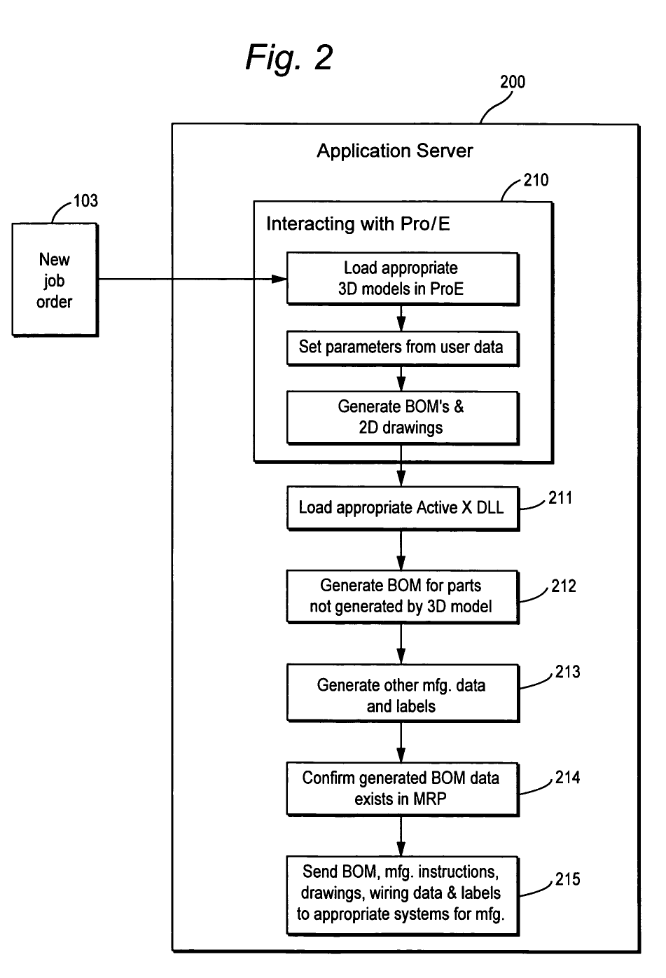

FIG. 2 illustrates an example procedure implemented on a computer, such as a server, for processing job orders and generating the drawings and other documents needed by a manufacturer for producing the ordered customized equipment (e.g., a cabinet/housing for an electronic controller). A new job order file 103 received from a user's computer is picked up by server 200 running the Pro/E™ application (210). At this point job file 103 is a Microsoft Access Database (MDB). A first process on server 200 takes the MDB and converts it to a text file that can be understood by the Pro/E loader (210). This text file is then placed in a directory that the Pro/E loader accesses to generate a Bill of Materials (BOM), AutoCAD drawings, Manufacturing Instructions and cabling labels.

Next, the Pro/E™ loader reads the text file and loads the appropriate 2D or 3D models based on one or more parameters of user data from the file. The Pro/E™ models have rules incorporated for generating BOMs and drawings. User selections such as, for example, the user's starting selection for a cabinet size, are passed into the ProE™ models from this text file. Regeneration then takes place on the models and then a BOM and AutoCad™ drawings are produced. One or more appropriate additional ActiveX™ DLLs are called (211), for example, to generate additional BOM information (e.g., parts not generated by the Pro/E™ models) along with manufacturing instructions and wiring labels (212 and 213). The ActiveX™ DLL uses the MDB to get the user's selections and works with a Microsoft™ SQL Server that has look-up information to generate the previously mentioned data (214).

Next, an output file that can be read by other entities and which contains the BOM, manufacturing documentation and instructions, wiring labels, etc. is generated for passing the information directly to other processing entities (215). For example, the generated AutoCAD drawings may be sent to a file server that is used by manufacturing and requisition engineering personnel or directly to the manufacturer, the label information may be sent to a file server that is used to print wire labels, and the manufacturing instructions and additional BOM information that was generated by the ActiveX DLL may be sent directly to a manufacturer or to an appropriate manufacturing requisition proposal (MRP) generating system or department.

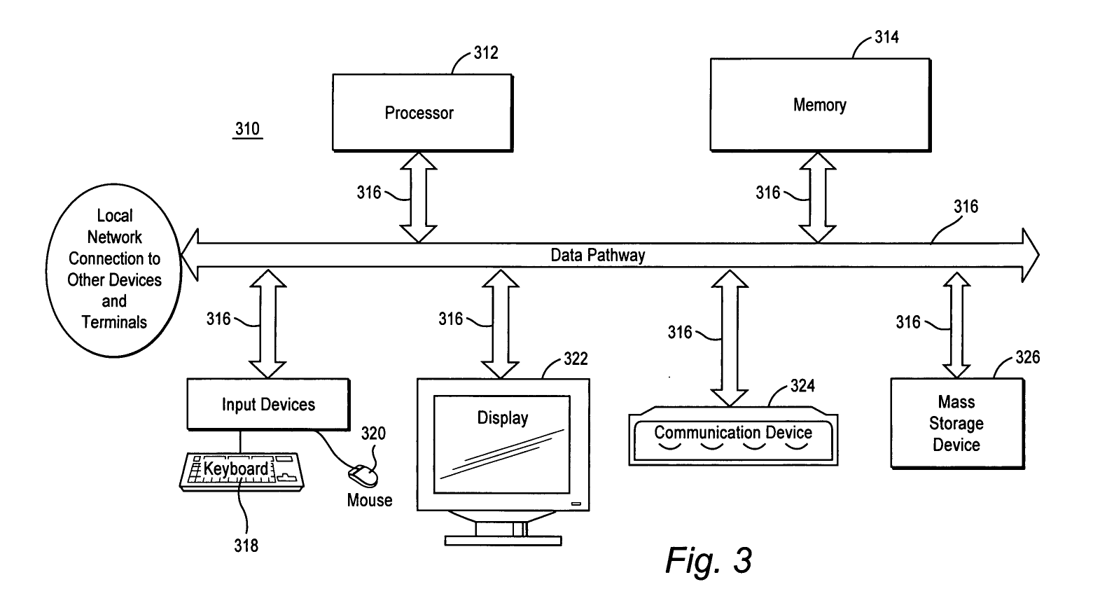

FIG. 3 shows a schematic diagram of an exemplary general-purpose computer system 310 in which the interactive graphic user interface (GUI) requisitioning tool 101 (FIG. 1) operates. The computer system 310 generally comprises a processor 312, memory 314, input/output devices, and data pathways (e.g., buses) 316 connecting the processor, memory and input/output devices. The computer system buses 316 may also be connected via modem or other appropriate device to a digital communications network (e.g., a LAN or WAN or the Internet) or to other devices and terminals. The processor 312 accepts instructions and data from memory 314 and performs various calculations. Processor 312 includes an arithmetic logic unit (ALU) that performs arithmetic and logical operations and a control unit that extracts instructions from memory 314 and decodes and executes them, calling on the ALU when necessary. The memory 314 generally includes a random-access memory (RAM) and a read-only memory (ROM), however, there may be other types of memory such as programmable read-only memory (PROM), erasable programmable read-only memory (EPROM) and electrically erasable programmable read-only memory (EEPROM). Also, memory 314 preferably contains an operating system, which executes on the processor 312. The operating system performs basic tasks that include recognizing input, sending output to output devices, keeping track of files and directories and controlling various peripheral devices.

The input/output devices may comprise a keyboard 318 and a mouse 320 that enter data and instructions into the computer system 310. Also, a display 322 may be used to allow a user to see what the computer has accomplished. Other output devices may include a printer, plotter, synthesizer and speakers. A communication device 324 such as a telephone or cable modem or a network card such as an Ethernet adapter, local area network (LAN) adapter, integrated services digital network (ISDN) adapter, Digital Subscriber Line (DSL) adapter or wireless access card, enables the computer system 310 to access other computers and resources on a network such as a LAN, wireless LAN or wide area network (WAN). A mass storage device 326 may be used to allow the computer system 310 to permanently retain large amounts of data. The mass storage device may include all types of disk drives such as floppy disks, hard disks and optical disks, as well as tape drives that can read and write data onto a tape that could include digital audio tapes (DAT), digital linear tapes (DLT), or other magnetically coded media. The above-described computer system 310 can take the form of a hand-held digital computer, personal digital assistant computer, notebook computer, personal computer, workstation, mini-computer, mainframe computer or supercomputer.

Those skilled in the art will appreciate that the non-limiting exemplary implementation of the automated customer interface and ordering system for requisitioning a manufacture of equipment and products as disclosed herein may be practiced with other computer-system configurations, including hand-held devices, multiprocessor systems, microprocessor-based or programmable consumer electronics, network personal computers (“PCs”), minicomputers, mainframe computers, and the like. The invention may also be practiced in distributed computing environments where tasks are performed by remote processing devices linked through a communications network. In a distributed computing environment, program modules may be located in both local and remote memory storage devices.

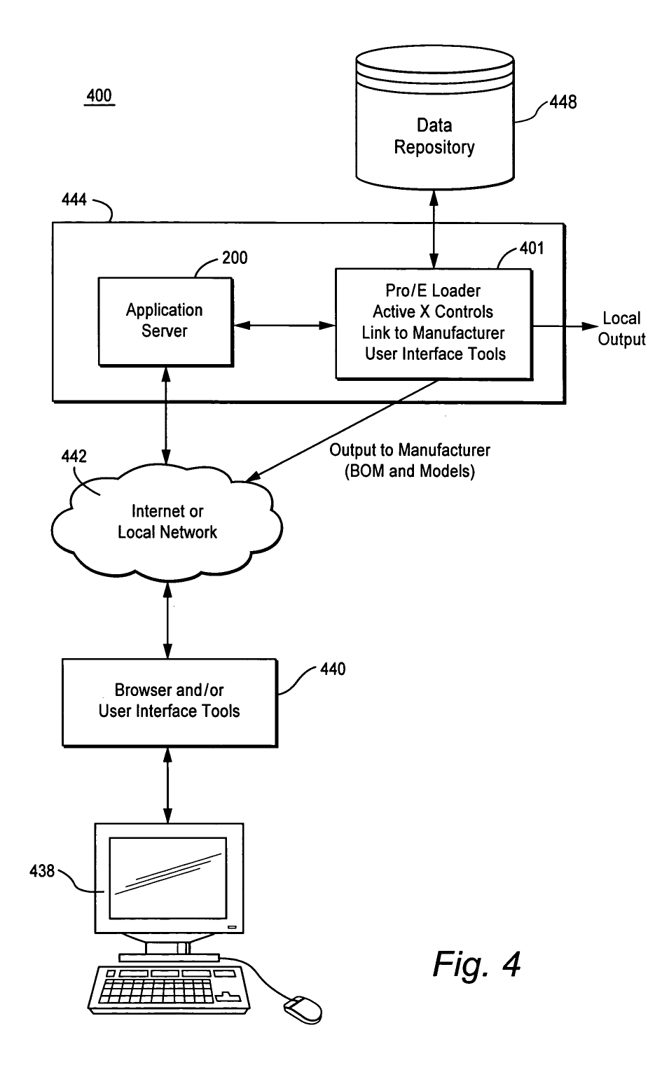

FIG. 4 shows an architectural diagram of a system 400 for implementing the exemplary ordering system 100 and interactive graphic user interface requisitioning tool 101 (FIG. 1) on a network. In this example, a user's computing unit 438 may either use the interactive user interface requisitioning tool 101 to access the MRP application server 200 over a private network or use a web browser 440, such as Microsoft INTERNET EXPLORER®, Netscape NAVIGATOR® or Mosaic®, to download or display the same interactive graphic user interface requisitioning tool application 401 stored on remote network application server 200. Computing unit 438 can take the form of a hand-held digital computer, personal digital assistant computer, notebook computer, personal computer or workstation. A communication network 442 such as the Internet or an electronic or wireless network connects the user's computer 438 to a network web server 444 which comprises MRP application server 200 (FIG. 1).

Computing unit 438 may also connect to a copy of the interactive user interface requisitioning tool software 401 at server 444 through a private network such as an extranet or intranet or a global network such as a WAN or the Internet. In addition to the Pro/E™ application and loader, ActiveX DLLs, links to manufacturers and other databases, network web server 444 maintains browser accessible (e.g., HTML web pages) and downloadable object code versions of the interactive graphic user interface 101 and requisitioning tools 102 (FIG. 1). However, the interactive graphic user interface requisitioning tools 401 do not have to be co-resident with the server 444 but may also reside in a separate data repository connected to server 444 or may be stored on an external computer-readable medium that is downloaded onto server 444 or user computer 438. For example, as illustrated in FIG. 4, web server 444 may be connected to a local or a remote network data repository 448 that may contain one or more databases for storing service information and manufacturer information and the like. In addition, data repository 448 or other external computer-readable medium (not shown) may be used to store a copy of the interactive graphic user interface 101 including one or more requisitioning tools 102 (FIG. 1) for loading onto a user computer device.

If desired, the ordering system 100 may have functionality that enables authentication and access control of users accessing the server 444 and using the interactive requisitioning tool 101. Both authentication and access control can be handled at the web server level by the user interface requisitioning tool 101 itself, or by a conventional commercial software security package such as Netegrity SITEMINDER™. Information to enable authentication and access control such as the user names, location, telephone number, organization, login identification, password, access privileges to certain resources, physical devices in the network, services available to physical devices, etc. can be retained in a database directory maintained, for example, in data repository 448 as shown in FIG. 4. The database directory can take the form of a lightweight directory access protocol (LDAP) database; however, other directory type databases with other types of schema may be used including relational databases, object-oriented databases, flat files, or other data management systems.

In the non-limiting example implementation of the ordering system disclosed herein, data repository 448 may be used to store service data such as information related to particular cabinet/housing systems such as templates, configuration information and definitions of components. The configuration information may include information for customers, cabinet/housing models, model parameters, equipment wiring requirements, etc. The data repository 448 may also contain historical service information such as the date that manufactured cabinets/housings were ordered and/or first put into service, components that have experienced failures, dates that the components experienced the failures and the position or positions of the failed components with respect to the other components. In addition, data repository 448 may include other service data such as changes made to components, repair histories (e.g., dates of service events, types of service events, etc.), etc. In the example system described herein, such service information may either be inputted manually or as part of an automatic data collection system.

In one example implementation, the interactive user interface requisitioning tool 101 runs on remote server 444 in the form of “servlets”, which are applets (e.g., Java applets) that run a server. Alternatively, the interactive user interface requisitioning tool 101 may run on server 444 in the form of Common Gateway Interface (CGI) programs. The servlets access the data repository 448 using, for example, Java Data Base Connectivity (JDBC), which is a Java application programming interface (API) that enables Java programs to execute structured query language (SQL) statements. Alternatively, the servlets may access data repository 448 using Open Data Base Connectivity (ODBC). As suggested above, using hypertext transfer protocol (HTTP), web browser 440 may obtain a variety of applets that execute graphic user interface requisitioning tool 101 on the user's computing unit 438.

In the non-limiting exemplary implementation of the ordering system as disclosed herein there are multiple levels or types of security that are implemented. So as to provide greater security and protection from unauthorized access, although any person may be added or registered as a “user”, users are categorized according to the following security options:
i. Super-User—A “super-user” is given the authority to create templates that are used in creating/placing job orders (i.e., manufacturing orders/requisitions). The super-user has the ability to make and save changes to enclosures, components, and connectors templates in the Templates Library. The super-user has ability to change security levels of all ordinary users.
ii. User (ordinary)—A “user” has only the ability to create jobs from templates. A user does not have ability to add or change items in the Templates Library. Users can query a super-user about problems and questions not answered in the user interface help file or user guide.
iii. Release and Non-Release Capability—The two types of “users” (super-user and user) each have two further levels of security: They may have permission to release a completed job order to the MRP application server (200) for further processing or they may be limited to only configuring a job order using the user interface tool without having the ability to release it.
   Example Implementation of Graphic User Interface Tools

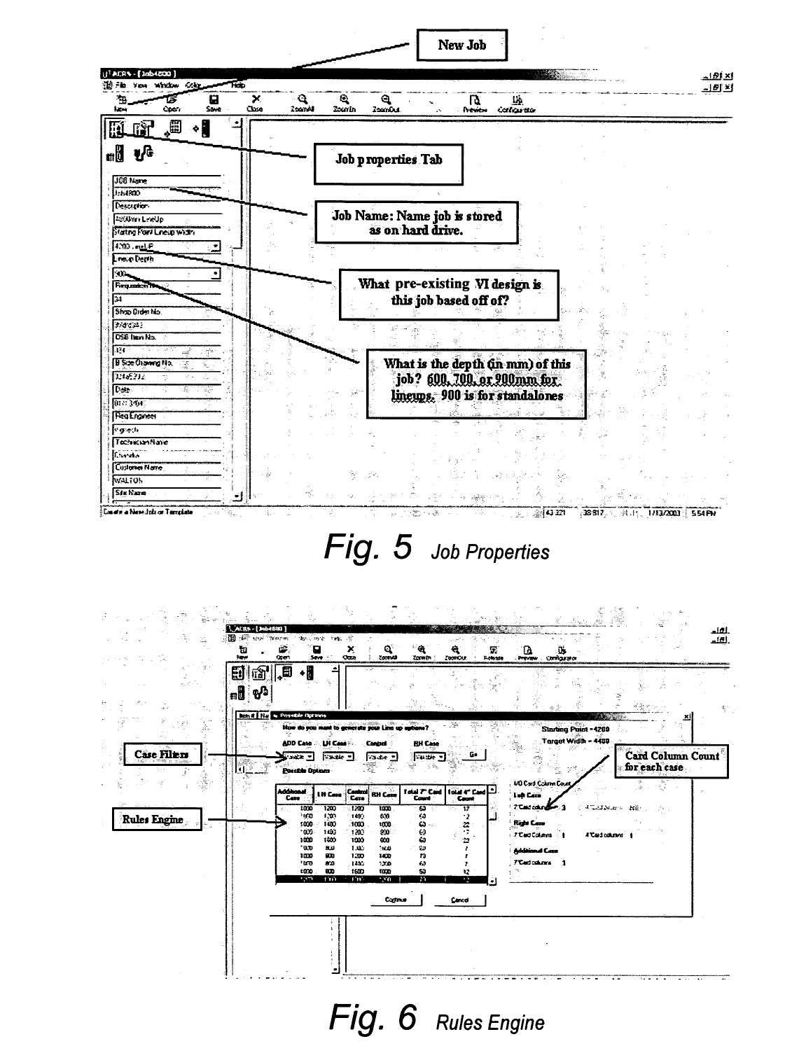

The following descriptions combined with the example graphic representations illustrated in FIGS. 5-39, provide one non-limiting example implementation and description of use of the user interface tools 102 (FIG. 1) as displayed by the graphic user interface 101 of ordering system 100 on a user's computer device. (This and other examples disclosed herein assume that the user's computer is running under a conventional Windows® type operating system.) A programmer of ordinary skill in the art will recognize that the computer source code for the following example implementations and associated screen displays can be authored without undue experimentation:

A non-limiting exemplary procedure for down-loading and running the interactive user interface tool 101 on a user's computer may be implemented as follows:
a. A super-user emails the link of the appropriate MRP server folder to the new (ordinary) user. The super-user at that time also provides the new user with a log-on ID and a password, and sets the security level for that new user;
b. The new user then installs the user interface 101 tool on the user's computer device/system, for example, by retrieving and double clicking on a “setup.exe” file provided from the folder address received from the super-user; and
c. The user interface tool 101 may then be run, for example, from the start menu or a shortcut on the desktop.
   The Job Properties Tab (FIG. 5)

To begin creating a new job order, a user would start by clicking the “New” button (or by selecting File->New->Job) in the example graphic user interface screen, illustrated in FIG. 5, that is displayed on the user's computer by user interface 100. Next, the user would click the “Job Details” tab (If the job is to be saved, the user fills out the text input fields shown in this window at the left side).

Next, the user would click on the “Go” button where an entered lineup width can be verified. If the entered width is correct, Rules Engine (see FIG. 6) will be displayed with all the possible configuration for the selected starting point and the target width. In addition to this information, the number of 7″ and 4″ cards along with the possible number of I/O card columns for each case is displayed.

Next, the user constrains the cabinet/housing enclosure by indicating which can grow and which are fixed in the case filter, and then the user clicks the ‘Go’ button to display the possible options. Then, the user would select the desired option in the rules engine to see the possible Card column count.

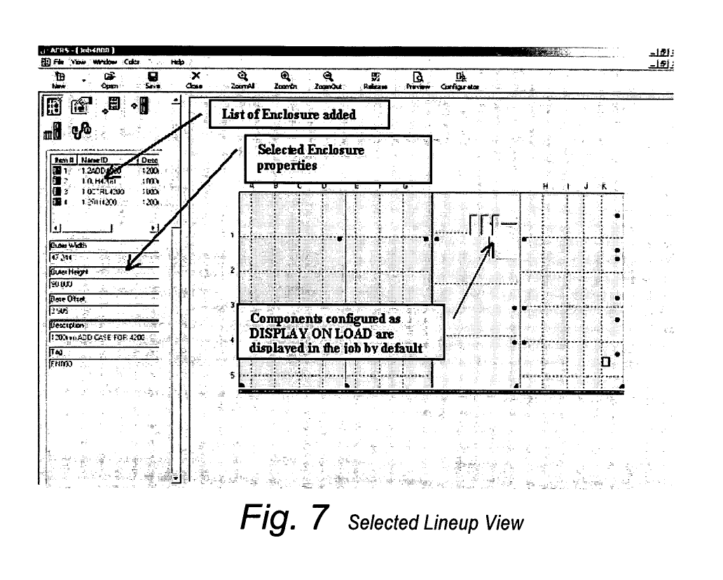

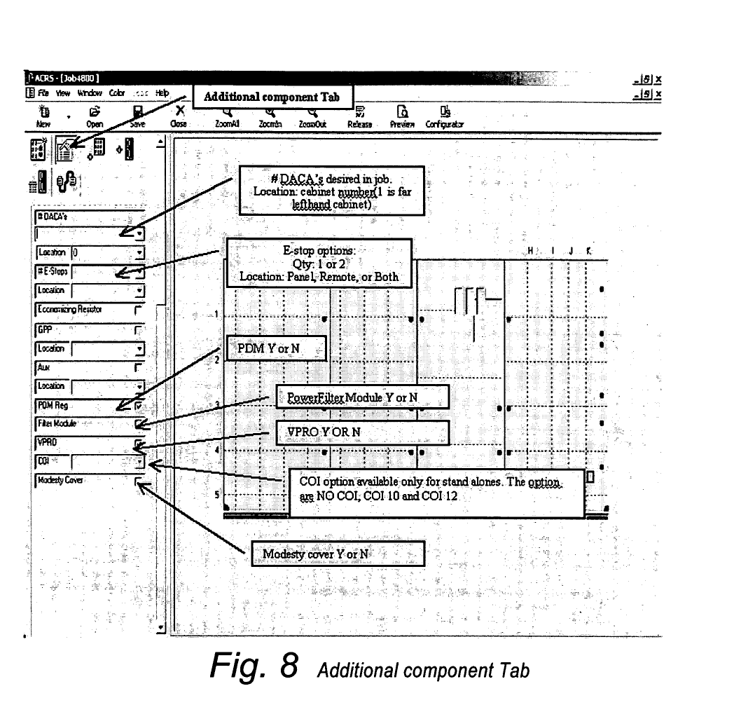

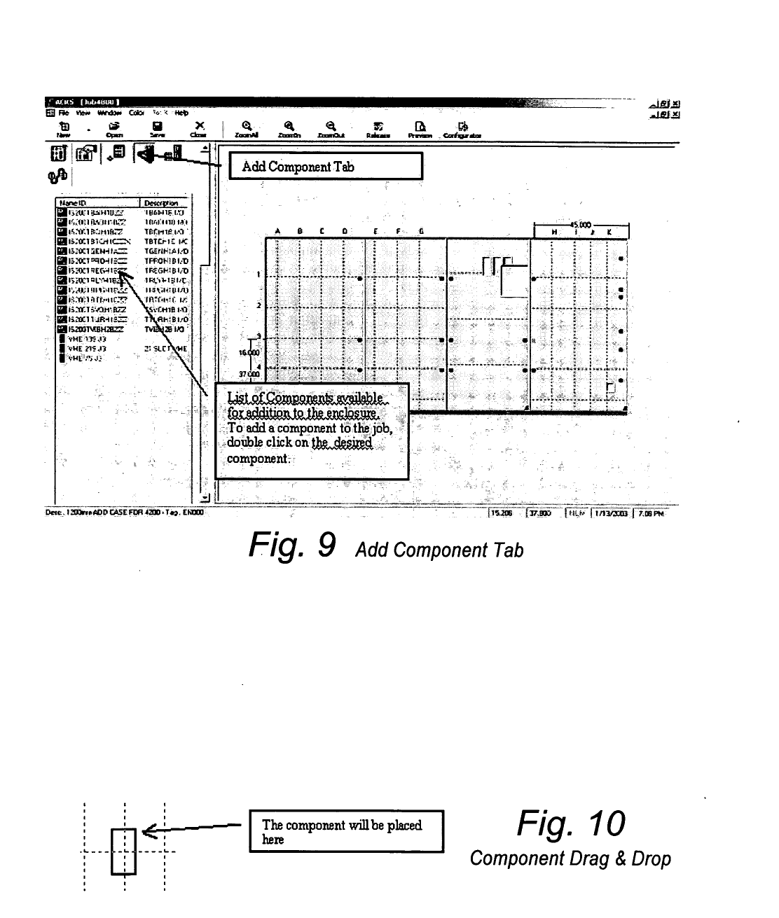

Next, the user would select the desired option and then click on continue to update the graphics with Lineup/Standalone template (FIG. 7). Different options listed under the Additional Component Tab (FIG. 8) may be selected by the user and are used to produce a correct Bill of Material. (Balloons next to the text input fields in FIG. 8 indicate example responses or choices input by the user.) The items with checkboxes will be added to the BOM if the item is checked. Location is indicative of which cabinet the item will be in. To add components (e.g., TB/IO cards, VME RACK) to the job, the user would click on the “Add component Tab” (FIG. 9).

The following table indicates example procedures for adding components to the Job:

TABLE 1

| Slot | | | | |
|---|---|---|---|---|
| No. | Component Type | Location | Moveable | Procedure to add the component |
| 1 | TB/IO CARDS | Add component tab. | Yes | Double click on the desired |
| | | | | component to add to the job. |
| 2 | Control RACK/ | Add component tab. | No | Double click on the desired |
| | VME RACK | | | component to add to the job. |
| | | | | Power supply is also added |
| | | | | along with |
| 3 | VME CARDS | VME RACK | No | Double click on VME RACK. |
| | | | | Double click on the Desired slot |
| | | | | and then choose the VME card |
| | | | | to add. |
| 4 | DACA | Additional | No | Select the DACA qty 0, 1 or 2. |
| | | component Tab | | |
| 5 | PDM | Additional | No | Check the PDM Reg. Check box. |
| | | component Tab | | |
| 6 | VPRO/ | Additional | No | Check the VPRO check box. |
| | PROTECTION | component Tab | | |
| | RACK | | | |
| 7 | MONITOR | N/A. Configured as | No | This component is required for |
| | | Display on Load in | | any Job. Therefore, it can Not |
| | | Monitor component | | be removed from the job. |
| | | Template | | |

Component Drag & Drop Feature:

A Component Drag and Drop feature of the user interface allows a user to easily customize the Job by inserting items from the template library by doing the following:
Double-click the desired component to insert it into the enclosure. The component should go to the bottom left-hand corner of the enclosure.
To move the component, hold down Ctrl+s while dragging the component to the desired location or right click on the TB component and select the move option from the menu and place the component in the desired location at the Column-Row intersection as illustrated in FIG. 10.

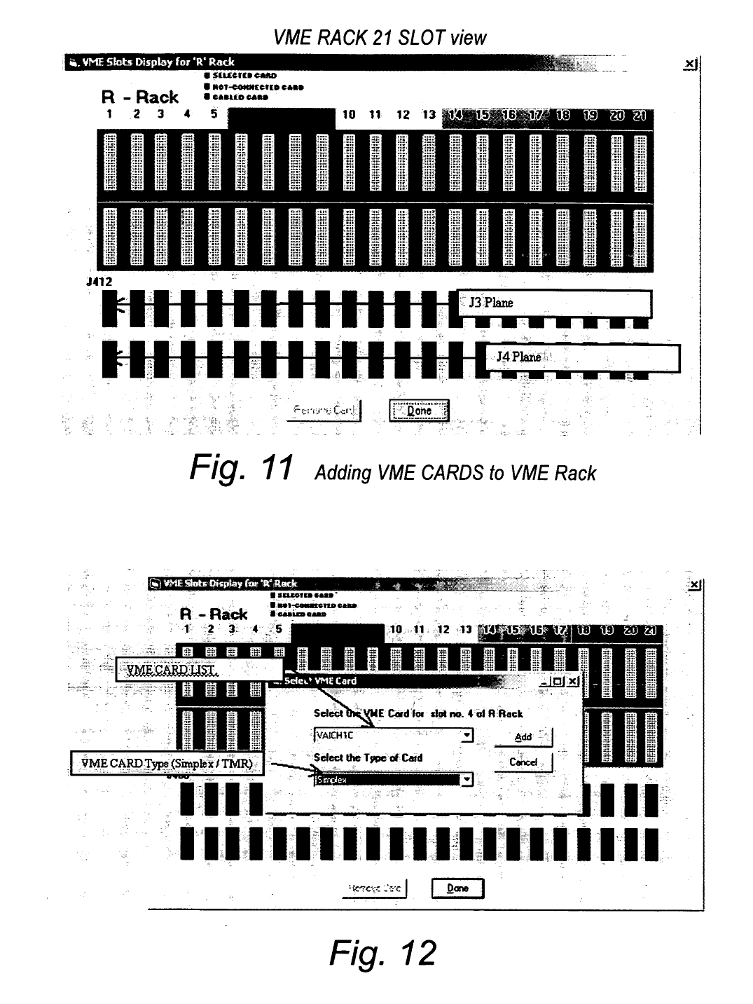

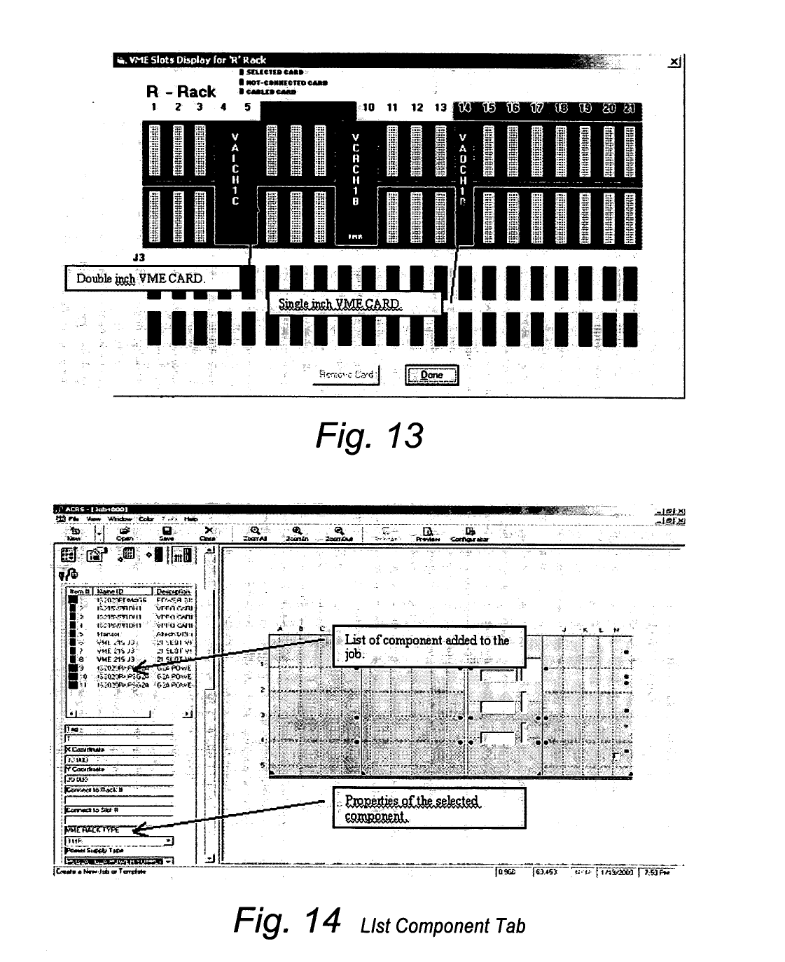

FIGS. 11 through 13 illustrate an example procedure for adding VME CARDS to VME Rack: First, add appropriate VME RACK to the JOB; then, double click on the VME RACK to see Rack's view (FIG. 11); then, double click on any of the slots to add VME CARD; next, select the VME card and card type from the drop down lists and click on the “add” button to add the VME CARD to the VME RACK (FIG. 12). The card will be displayed as added in the RACK VIEW (FIG. 13).

The List Component Tab (FIG. 14):

The List Component Tab, shown in FIG. 14, provides an interactive screen that lists all the components added to the current Job. To view the properties of the added component, select the component from the component list. The properties of the selected component will be displayed below the component list. There are a few properties which a user can change: For Example, if a VME RACK is selected, the user may change the VME RACK TYPE from TMR to Simple and vice versa. Also, a Power Supply type may be changed from G2A to G3A. The following is list of some example properties available for components that are displayed in the List Component Tab screen illustrated in FIG. 14:
1. Tag: Is the text the component will be identified with when the mouse drags over that component. Will also be used to route cables to and from.
2. X Coordinate: The location of the component can be controlled with this coordinate. The coordinates zero point is a black dot located somewhere on the enclosure. It is the X-axis of the component location.
3. Y Coordinate: The location of the component can be controlled with this coordinate. The coordinates zero point is a black dot located somewhere on the enclosure. It is the Y-axis of the component location.
4. Row: If the component is a TB card the row number the card was dropped in will be displayed. The row number can be changed to manage card placement.
5. Level: If the component is a TB card the level of the card can be specified in this field. Upper level will offset the card on the screen to indicate its status. The field defaults to lower level.
   Deleting a Cable

To delete a wiring cable, the user would select the cable for deletion from the component list and click on a displayed delete (“X”) button.

Editing a Cable Information

To edit a wiring cable, the user would, for example: 1) Select the cable for which you want to edit the information; 2) Click on the Edit Button; then 3) Modify the cable information; and then 4) Click on save button to save the chances or click on the “abort” button to cancel the operation.

Releasing a Job

A user may work on creating one or more job orders. A partially completed job order may be saved for further work at a later time. When the user completes a particular job order configuration, the configured job is sent to the next stage of processing at server 200 (FIG. 2) by clicking on “Release” button from Tool bar.

Template Libraries (FIG. 15)

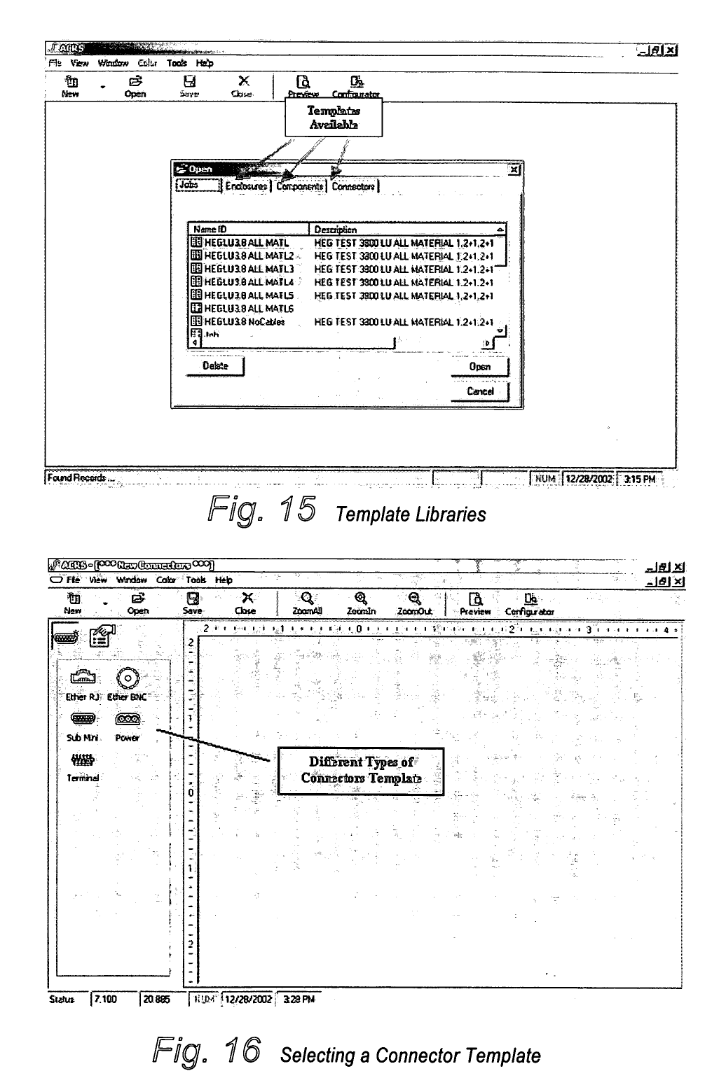

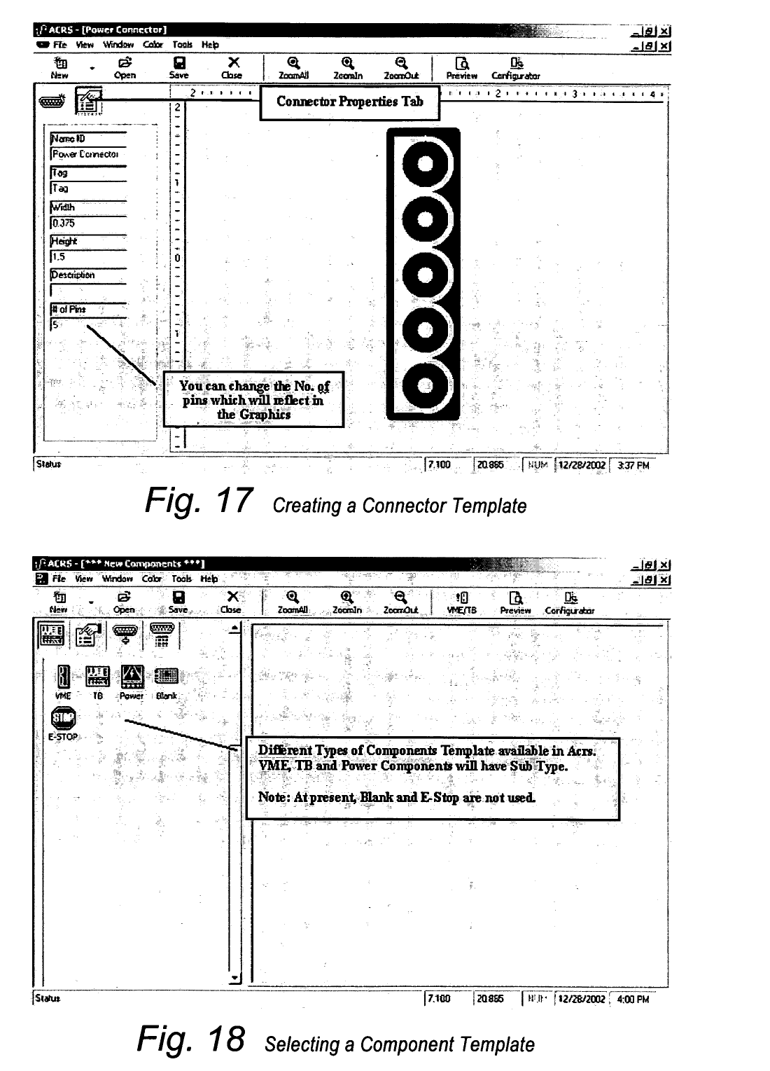

The Template Library is a collection of approved items available to be added to a particular job. Preferably, only a “Super User” has authority to add additional items to this library. In this disclosed non-limiting example implementation of a customer interface and ordering system for electrical equipment cabinets, there are three sub-categories within the template library: 1) Connectors; 2) Components: TB cards, VME cards, PDM's and DACA's; and 3) Enclosures. In FIG. 17 a screen display window is shown which is displayed by user interface 101 after a user selects the “open” button on an initially displayed screen. In this instance, the “Jobs” tab is selected and the window displays a listing of “open” jobs currently being configured by the user. As illustrated in FIG. 15, the different Template Library sub-categories shown as separate “tabs” at the top of the “Open” window and may be individually selected (opened) by a user to display new windows used for creating and selecting items/components to add to the job from each sub-category. However, for enhanced security, a “super user” may be given the exclusive authority to delete or create new templates for the Template Libraries.

Selecting and Creating a Connector Template

FIGS. 16 and 17 illustrate example display windows provided by the graphic user interface for creating and selecting a connector template. In this example of a “connectors” sub-category window shown FIG. 16, the different types of connector templates which are available to a user are displayed as icons in a selection box at the left side of the window. Referring now to FIG. 17, an illustration of how a user would use the interactive interface 101 to create a “Power” Connector is shown. First, the user would click on File->New->Template and select the connector tab option and click Open. Next, the user selects the “Power” icon from the list of option. Next, the user would click on the “connector properties” tab which results in the display of various text entry fields such as fields for “Name ID”, “Tag”, “Width”, “Height”, “Description” and “#of Pins” (as illustrated in FIG. 17). The user then enters the appropriate information in the displayed text fields and then clicks on a “Save” button displayed on the same screen. The selected connector is then created by the user interface and saved in a database which can be used in the creation of component template.

Selecting and Creating a Component Template

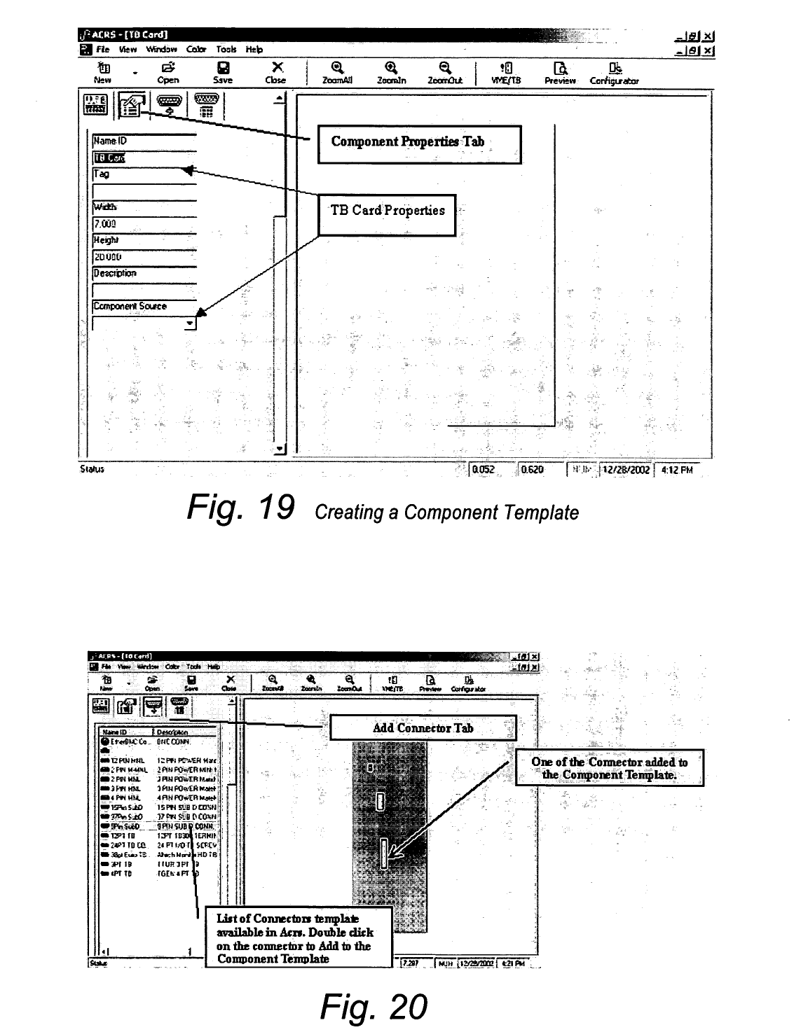

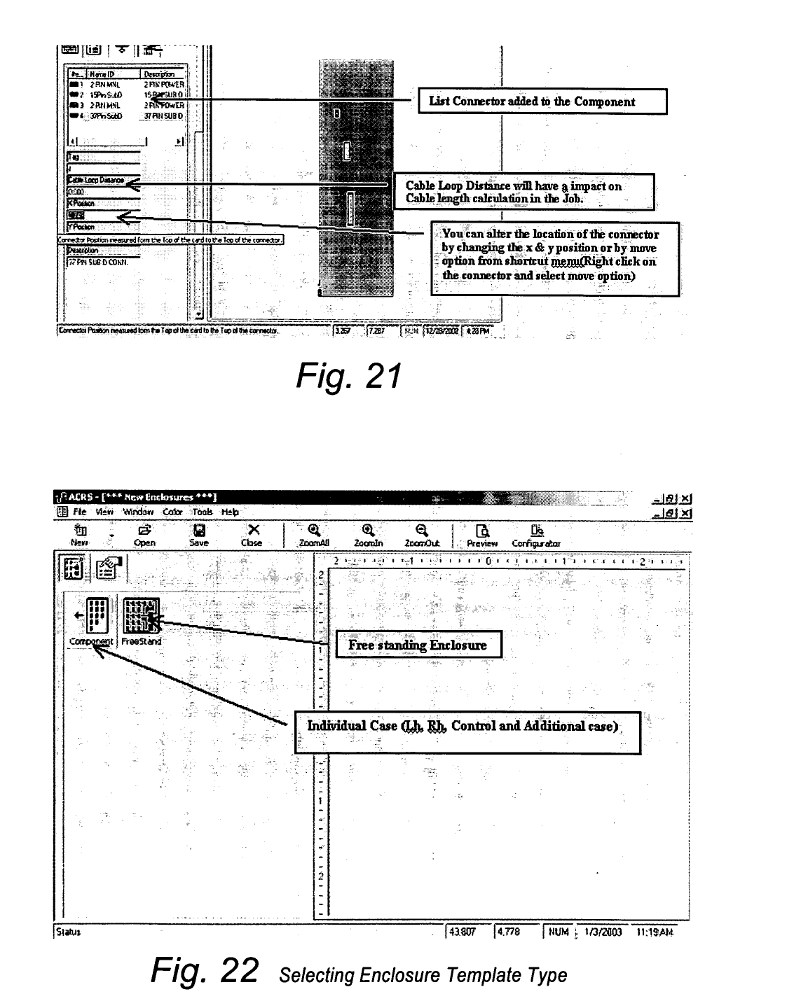

FIGS. 18 through 21 illustrate example display windows provided by the graphic user interface for selecting and creating a component template. In this example of a “components” sub-category window, the different types of component templates that are available to a user are displayed as icons in a selection box at the left side of the window shown in FIG. 18. Certain types of components may also include sub-component types. Referring now to FIG. 19, an illustration of how a user would use the interactive interface 101 to create a “TB” card component is shown. First, the user would Click on File->New->Template, then select Component option and then click on “Open”. Next, the user would Select “TB” template from the list of icons; then, the user would select the component properties tab which results in the display of various text entry fields such as fields for “Name ID”, “Tag”, “Width”, “Height”, “Description” and “#of Pins” (as illustrated in FIG. 19). Next, the user would enter the TB Card Name, Tag, width, Height, Description and Component Source. Next, as illustrated in FIG. 20, the user selects the “Add Connector” tab to add the selected connector to the TB component. In addition, on the right side of the same window, the user may also view a displayed graphic of the cabinet and configure the position of connectors selected from the Connector tab. Finally, as illustrated in FIG. 21, the user can click on the “Save” button to save the component to the component list. The newly created component then becomes available for the user to add into a job order.

Selecting an Enclosure Template Type and Creating an Enclosure Component

FIGS. 22 and 23 illustrate example display windows provided by the graphic user interface for selecting a new enclosure template type and creating an enclosure component. In this example of a “Enclosures” sub-category window, the different types of enclosures that are available to a user are displayed as icons in a selection box at the left side of the window as shown in FIG. 22. In the non-limiting example shown in FIG. 22 there are only two types of enclosures available to select: 1) “Component” (an individual case which will form a lineup) and 2) “FreeStand” (a free-standing enclosure). Referring now to FIG. 19, an illustration of how a user would use the interactive interface 101 to create an Enclosure component is shown. First, a user would click on File->New->Template, then choose the Enclosure option, and then click on “Open”. Next, the user would click on the “Component” option. Next, as illustrated in FIG. 23, the user would enter the “Name Id”, “Tag” (selected from a displayable drop down menu), “Outside Width” (in inches), “Outside Height” (in inches), “Base offset” (in inches), “Description”, “Standard Width” (in mm for reference) and “Starting Point” (selected from the drop down men). Next, the user would proceed to add an I/O Column and Row, and then add I/O and Power Cable Nodes, as explained below, and then click on the “Save” button.

Adding/Changing the Measurement of an I/O Column and Row

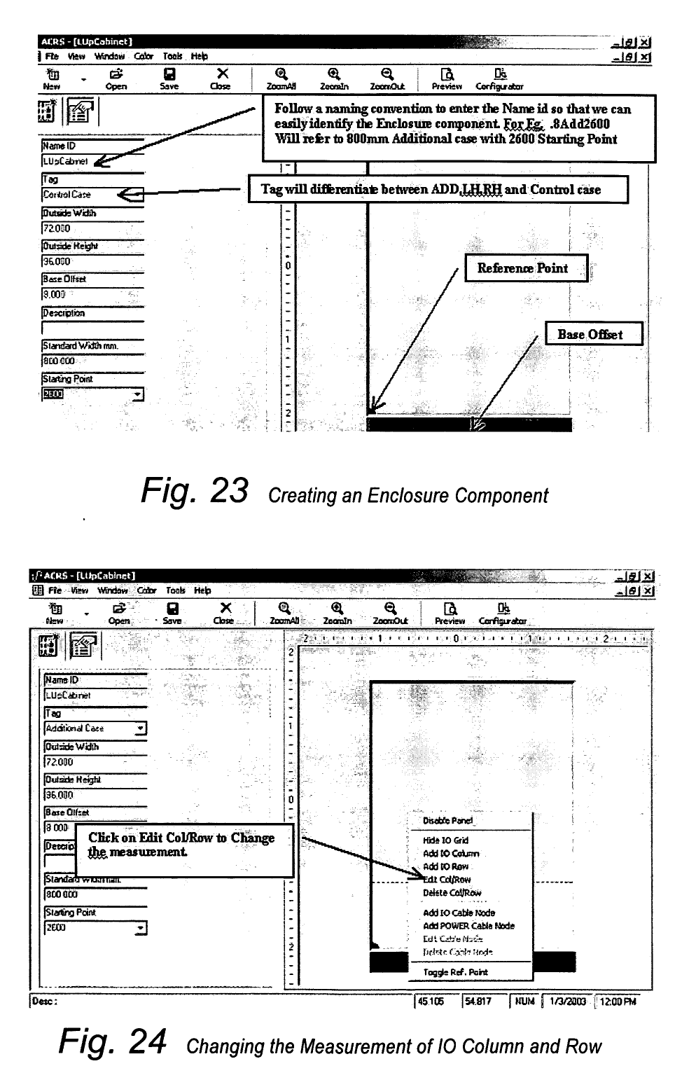

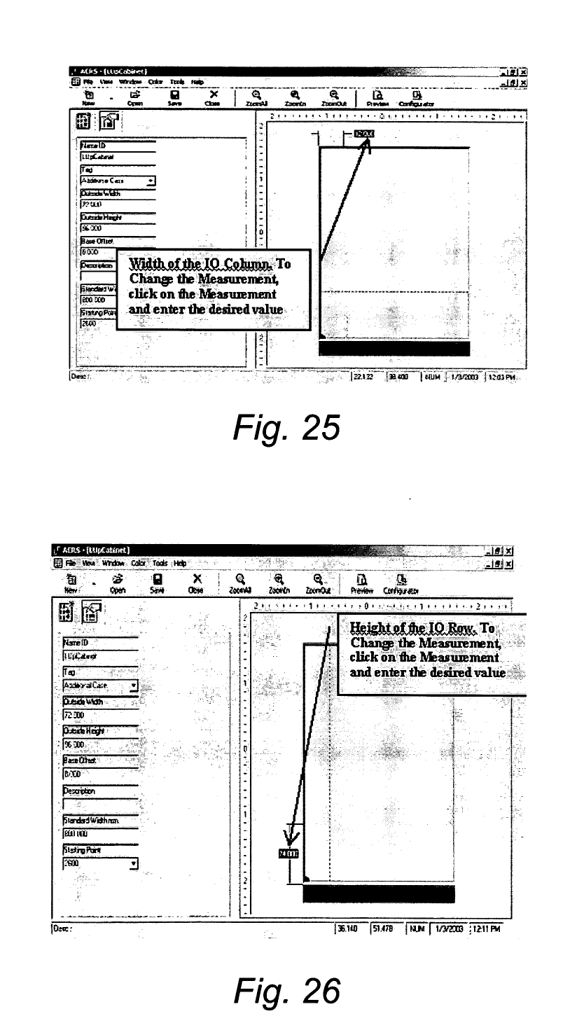

FIGS. 24 through 26 illustrate example display windows provided by the graphic user interface for adding and/or changing the measurement of an I/O column and row. First, the user would select the appropriate I/O Column or Grid by clicking on the a Column grid line displayed in the right-hand portion of the displayed window (see FIG. 24). This action will cause a displayed color of the selected column to change (for example, where a Yellow color represents the selected column or Row, the color could change from Black to Yellow). Next, the user would right click on the I/O Column or Row which would activate the displaying of a short-cut menu, as illustrated in FIG. 24. The user would then select on of the displayed appropriate actions from the menu such as “Add I/O” or “Edit Col/Row”. The graphic user interface would then carry out the selected action and, for example, display the measurement of the I/O column at the top of the displayed Enclosure window (as illustrated in FIG. 25) or the IO Row at the left of Enclosure window (as illustrated in FIG. 26).

Adding Cable Nodes (IO and Power)

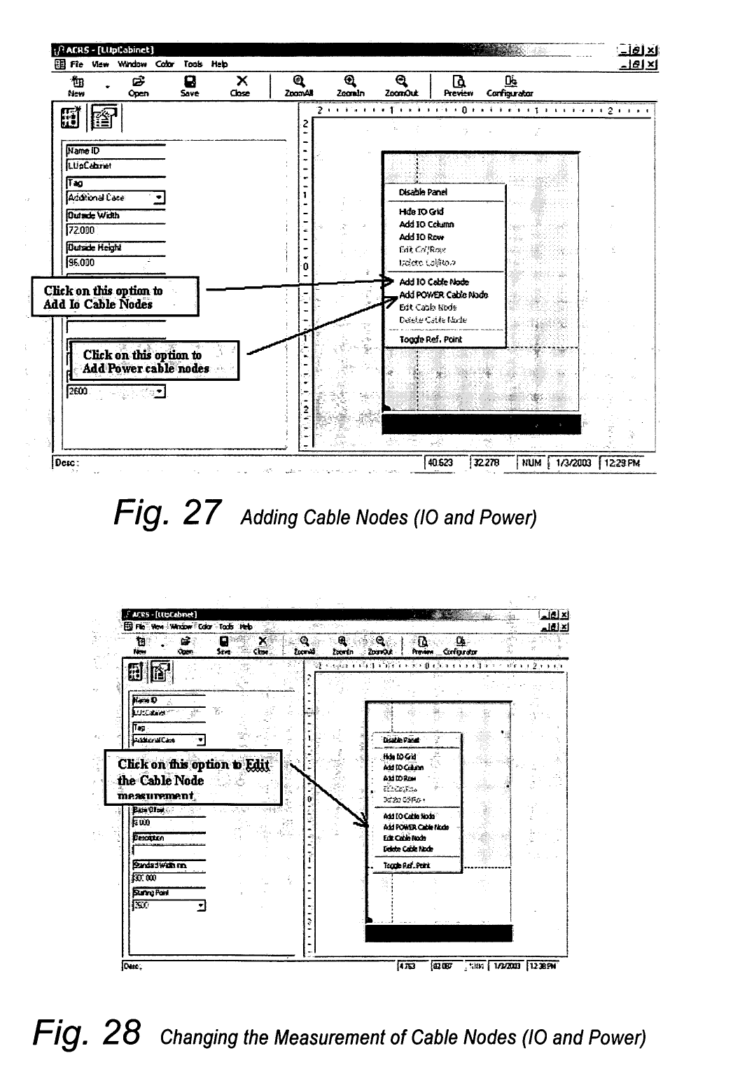

Cables are routed through Cable Nodes. I/O cables may be routed thru I/O Cable Nodes (which is displayed as a black circle) and Power cables may be routed through Power Cable Nodes (which is displayed as a Red Circle). A user may add cable nodes by right clicking on the Enclosure component to activate the short cut menu, then clicking on Add I/O Cable Node or Add Power Cable Node options to add cable nodes to the current mouse pointer position in the display, as illustrated in FIG. 27.

Changing the Measurement of Cable Nodes (IO and Power)

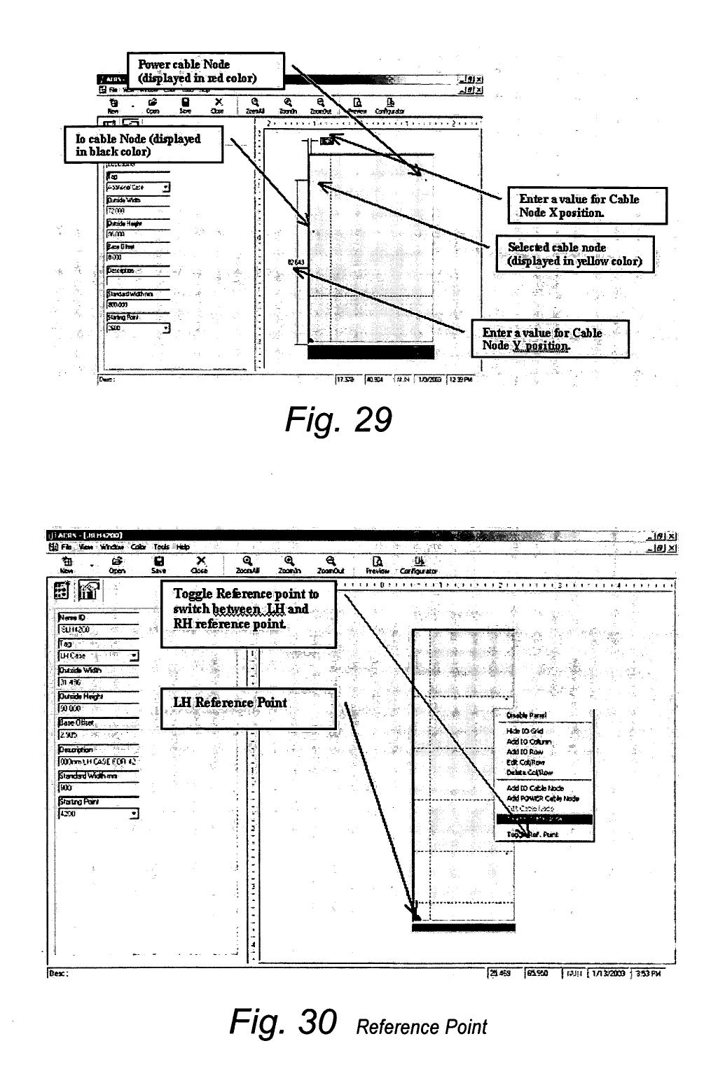

As illustrated in FIGS. 28 and 29, to change the measurement of the cable nodes, the user selects the cable node (I/O or Power) by clicking on the cable node. The selected cable node will then be displayed in a different color. Next, the user would right click on the selected cable node to activate the shortcut menu, then select the Edit Cable Node option and the measurement (x,y) value will be displayed on the screen. Next, the user clicks on the displayed measurement and enters the desired value to change the measurement.

Setting Component Reference Points (FIG. 30)

A Reference Point indicates the measurement system of the Enclosure. (The reference point position has an impact on cable length calculation.) The reference point can be in either LH or RH. When the reference point is at Left-Bottom corner, then it is said to be LH reference point. When Reference point is at Left-Bottom of the case (LH reference point), component in JOB-Enclosure will be placed at a distance X from the Left edge of that case. If the reference point is at Right-Bottom corner (RH reference point), then it is said to RH reference point. When Reference point is at Right-Bottom of the case, component in JOB-Enclosure will be placed at a distance X from the Right edge of that case. By default the component template will have LH reference point (Left Bottom corner of the case). You can toggle the reference point to RH, by using Toggle Reference point option. The user can view the Toggle Reference Point option by right clicking on the Component Template.

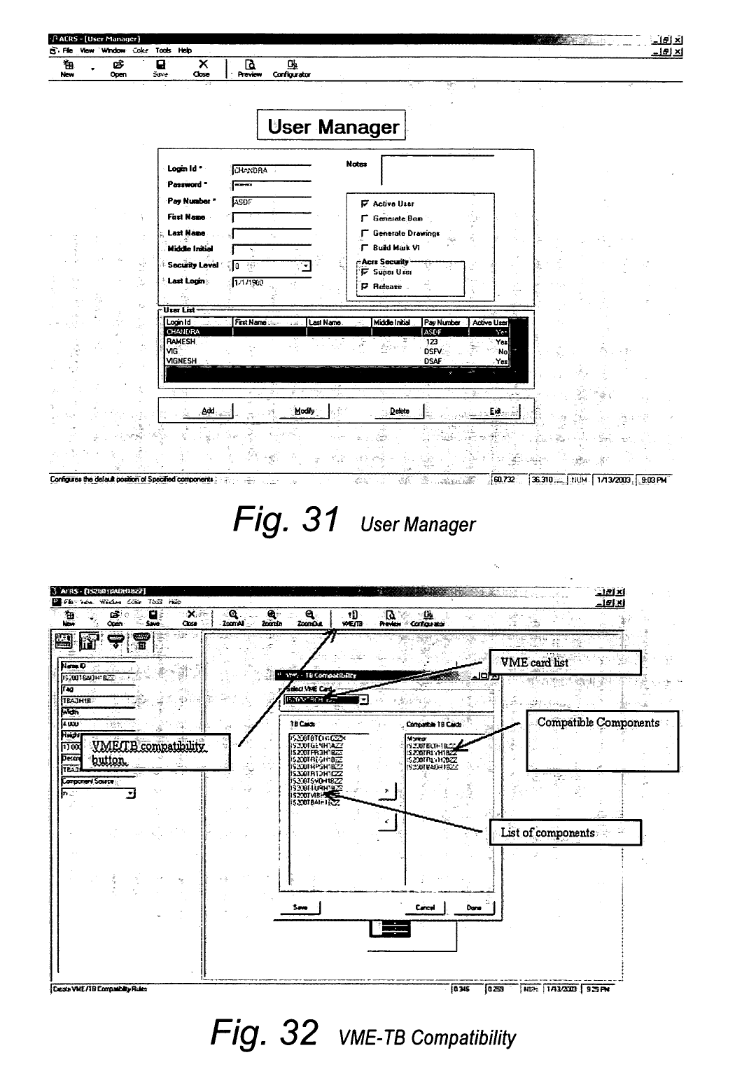

The User Manager Menu (FIG. 31)

A special User Manager menu is used to set up different user security. As discussed above, in the non-limiting example disclosed herein, three types of user security are employed: A Super-user, a User (ordinary), and each may have either Release or Non-Release capabilities. The User Manager menu is available only to a Super-user. The Super-user can Add, Modify user profile and delete the user. An example User Manager menu, which may be accessed by selecting Tools->User Manager, is illustrated in FIG. 31.

VME-TB Compatibility (FIG. 32)

FIG. 32 illustrates an example display window provided by the graphic user interface for implementing VME-TB Compatibility. The VME-TB compatibility utility is used to set compatibility between VME CARDS and TB CARDS. This will not allow the user to route cable between two in-compatible cards. To access the VME-TB compatibility, the user opens a component template by selecting File->Open->select Components tab and double clicking on any one of the Components to open the utility. The following description, with reference to FIG. 32, covers an example process for a user to follow to set compatibility between a VME and a TB card: First, the user opens the VME/TB compatibility utility, Next, the user selects the VME card for which the compatibility has to be set. Next the user selects the TB card and clicks on the “>” button, then the user clicks on the “Save” button to update the database. Next, the user would click “Done” to Exit VME/TB compatibility.

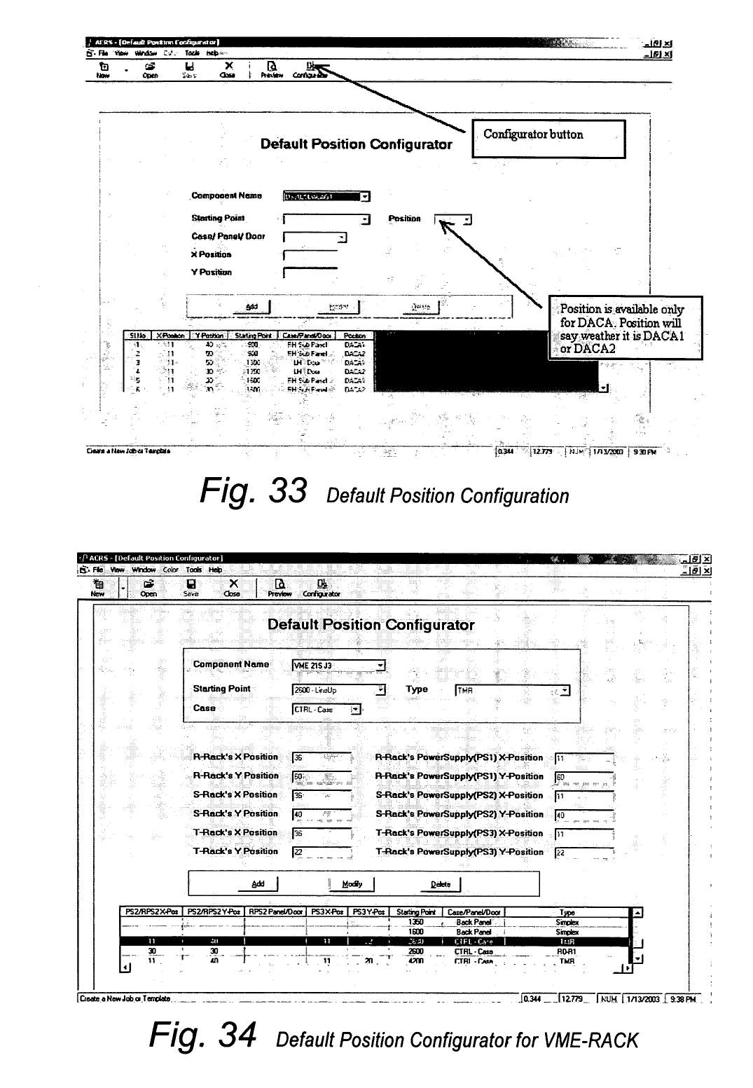

Default Position Configuration (FIG. 33)

FIG. 33 illustrates an example display window provided by the graphic user interface for implementing a Default Position Configurator feature (DPC). This feature configures positions (X,Y) for DACA, PDM, Power Supply, VME-Rack, VPRO (Protection Rack) and Monitor components which have Default Position option, checked in their Component Template Properties. The placement of the components in the job Enclosure may be decided from the locations entered for respective components using the DPC. Components like PDM, DACA, VPRO (Protection rack), VME RACK (Control Rack), and Monitor should be placed in the correct position so that cable length calculation will be error free. Each component will have different location depending upon the starting point of the particular equipment design. The user interface for DACA, PDM, MONITOR and VPRO (Protection rack) will be mostly similar, as illustrated in FIG. 33.

As illustrated by the text input boxed shown in FIG. 33, the DPC accepts a component's position for each starting point as follows (the (X, Y) point of a component refers to Left-Bottom position of the Component):
a. Case/Panel/Door—where the component may reside;
b. X—the Horizontal distance from Left edge (if the reference point is in the Left-Bottom corner of the case/door/panel or Right edge if the reference point is in the Right-Bottom corner of the case/door/panel) of the Case/Door/Panel; and
c. Y—the vertical distance from top of base of the Case/Door/Panel.

DACA and RACK components requires position information for some special cases as follows:
1. For each starting point, DACA requires locations (Case/Door/Panel and (x, y) position) for DACA1 and DACA2, i.e., when 2 DACAs are to be placed. When one DACA is to be placed in the JOB Enclosure, DACA1's position is used.
2. For each starting point, (7, 13 and 21 slot) RACK requires locations for different configurations (TMR, R0-R1, Simplex and Simplex with Redundant Power Supply).
   I. 7-Slot RACK requires Locations for TMR (1-Rack's location as all R, S and T racks are packed into a single Rack) and Simplex (1-Rack) configurations. It accepts data for 900 starting point alone.
   II. 13-Slot requires Locations for Simplex (1-Rack) configuration for 900 starting point only.
   II. 21-Slot Rack requires Location for
      a. TMR (3-Racks) for 2600, 4200 and 1350 starting points;
      b. R0-R1 (2-Racks) for 2600 and 1350 starting points
      c. Simplex (1-Rack) for 1350, 1600 and 900 starting points
      d. Simplex with Redundant Power Supply (1-Rack) for 900 starting point.

Power Supply component's Locations are obtained along with RACK configuration. The number of power supplies for each configuration is similar to that of the number of Racks except for Simplex with Redundant Power Supply configuration where locations for 2 Power supplies are accepted while only one Rack exists.

The Configurator displays a pick that contains a list of Components' NameIDs, which require default position to be configured, i.e., their Default Position property in the Component Template is checked (or set to true). Selecting one of the components from the pick updates the User Interface accordingly and shows input provisions for required data that are not yet enabled. Clicking on ADD button enables the Input provisions and once the data are entered, the user can click the Update button, which adds your data into the Grid provided. The user can also modify an entered data by selecting the respective row from the Grid. Selecting a row will display its content in the Input provisions, which will be disabled. Clicking on Modify button will enable them and after modifying them, the user may click on Update, which will commit the changes into the Grid. The Cancel button may be used to cancel any changes that had been made for that row. Simply selecting the row and clicking on Delete button can delete any row in the Grid.

Default Position Configurator for a VME-RACK (FIG. 34)

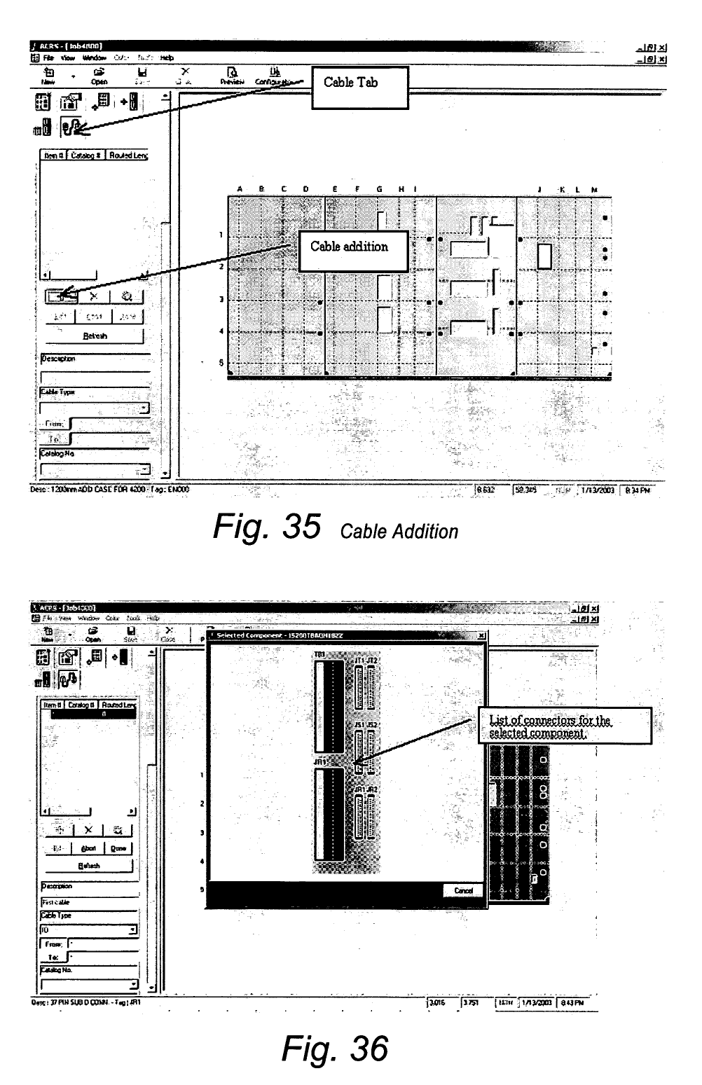

FIG. 34 illustrates an example display window provided by the graphic user interface of the user interface for implementing a default position Configurator for a VME-RACK. The default position Configurator user interface display window appears mostly different for VME-RACK when compared to other components like PDM, Monitor etc. For VME rack, the user needs to provide the component location for Rack as well as Power supply. For TMR configuration, three rack and power supply information will be required. For Simplex configuration, single rack and power supply information will be enough. To create a default configuration for components, a user would:
1. Open the Configurator by clicking on “Configurator” button from the tool bar to enter the Default position for components; then
2. Select the component pick for which you are providing the default position (the user interface will be updated for the selected component); then
3. Click on Add button and fill in the appropriate information in the input fields; then
4. Click on Update to Update the Grid; and then
5. Click on Save (from the tool bar) to commit the changes to the database.
   To modify the existing configuration, a user would:
1. Select the component to modify the default position;
2. Select the row from the grid to modify;
3. Click on Modify button, and make the necessary changes to the values in the input fields;
4. Click on Update to update the grid; and then
5. Click on save to save the changes to the database.
   Cable Addition (FIGS. 35 Through 37)

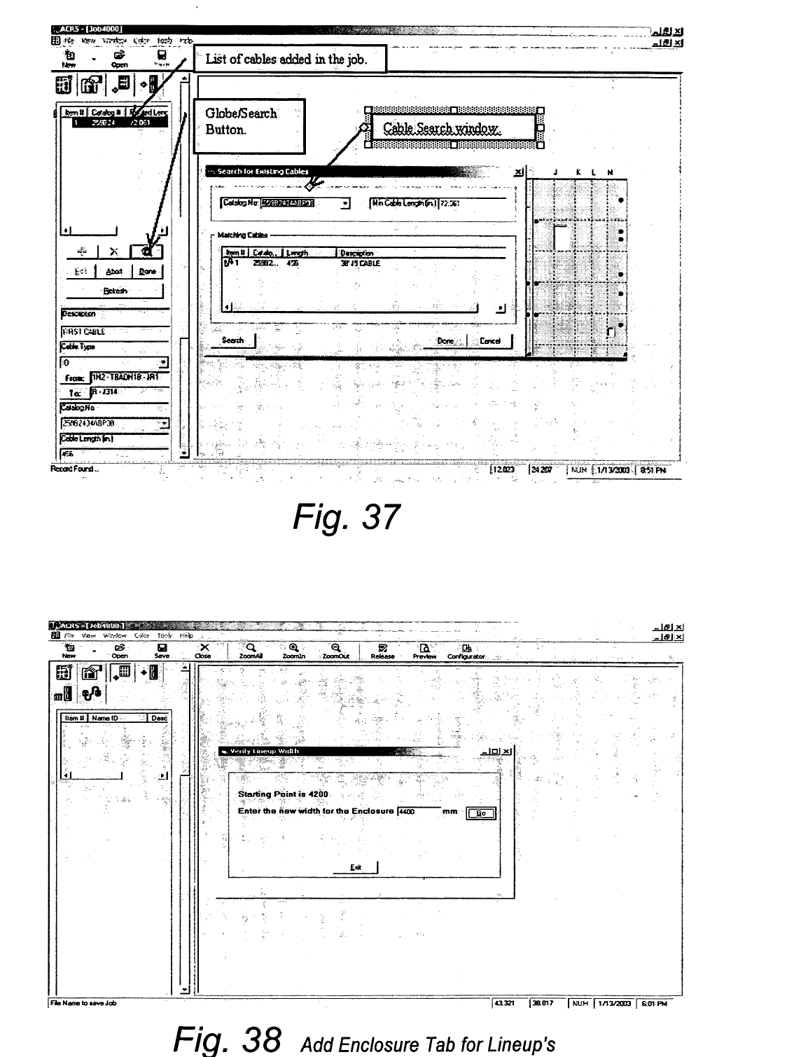

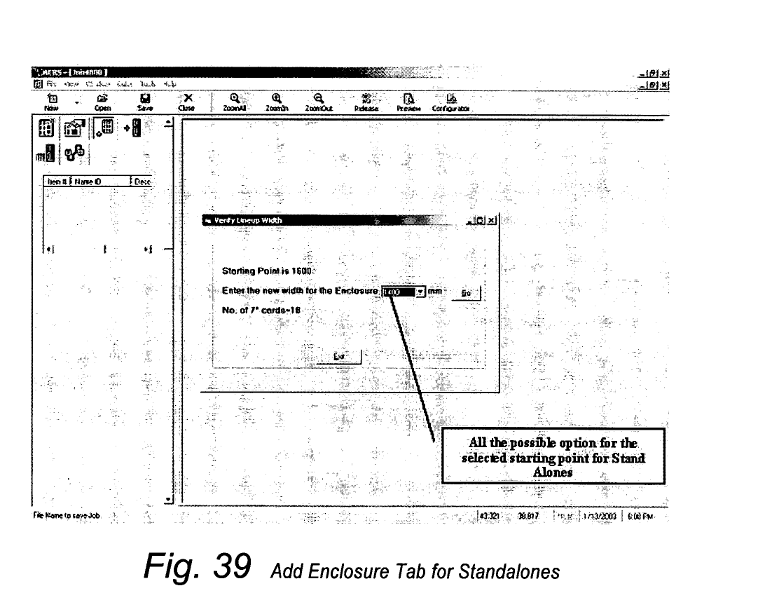

FIGS. 35 through 37 illustrate example display windows and procedures provided by the graphic user interface for allowing a user to add and configure wiring cable to the cabinet design. A user would do the following to configure the cable routing for the cabinet/housing:
1. Click the + button (FIG. 35);
2. Enter the Description and select the Cable Type;
3. Click the From button;
4. Click the component to start routing from (the user may select a I/O cable and select power component);
5. A window (FIG. 36) will open with detail of the connectors on that component;
6. Click on the connector desired for the connection;
7. Click the To button;
8. (If the To component is a VME CARD, then click on the VME RACK and select the VME CARD. Acrs will not allow to route cable between incompatible cards. If there is no connector on the VME CARD, you can connect it to “J3” or “J4” plane.)
9. Click the component to end routing;
10. A window will open with detail of the connectors on that component;
11. Click on the connector desired for the connection;
12. Hold down Ctrl+C while clicking on the cable origination point or right click on the component (n/a for VME RACK) and select the route cable option from the menu);
13. Specify the cable path by clicking on one of the cable nodes;
14. Continue clicking nodes until satisfied with cable path;
15. Click on cable destination;
16. A calculated length will now be visible in the properties window;
17. Click the search button/globe;
18. A cable search window will open (see FIG. 37);
19. Click search to find all cables available of similar length;
20. Highlight the cable desired for the application;
21. Click done;
22. Fill in the cable description window if desired; then
23. Repeat steps 1 thru 21 for all cables.
   Adding an Enclosure Tab (FIGS. 38 and 39)

FIGS. 35 through 37 illustrate example display windows and procedures provided by the graphic user interface for allowing a user to add an Enclosure tab. To invoke this feature, the user would go the Add Enclosure tab, click on the tab which provides a Verify Lineup Width window (FIG. 35). The user would then enter the desired width (for lineup's) or select the desired width from the pick (for standalones) and then click on the “Go” button (FIG. 37).

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A graphic user interface and computerized ordering system for ordering customized equipment, comprising:
a user computer device connected to a digital communications network, said user computer device having an interactive graphic user interface for aiding a user in configuring one or more manufacturing requisition proposals for ordering a manufacture of equipment; and
a server computer connected to said digital communications network for receiving data from said user computer, said server computer running an application for processing data received from said user computer and generating at least a materials-related document relating materials for equipment and a set of engineering drawings associated with said one or more manufacturing requisition proposals.

2. The graphic user interface and computerized ordering system of claim 1 wherein said server computer executes a 3-D modeling application for generating 3-D engineering drawings based on data received from said user computer.

3. The graphic user interface and computerized ordering system of claim 1 wherein said interactive graphic user interface includes a rules engine tool for validating selected information input by a user.

4. The user interface and computerized ordering system of claim 1 wherein the interactive graphic user interface comprises one or more interactive windows displayed by said computer device on a display device for aiding the user in configuring a manufacturing requisition proposal for a cabinet/rack-mounted housing for electronic equipment.

5. An interactive user interface requisitioning tool and computerized ordering system, comprising:
an interactive user interface component that runs on a user's computer device and provides one or more interactive graphic display windows for enabling a user to configure a manufacturing job order; and
a job order processing component, responsive to job order files created by the user interface component for generating manufacturing requisition proposal (MRP) information,
wherein said user interface component is implemented on a user's computer and provides job order files via a digital communications link to an applications server which implements said job order processing component and communicates said MRP information to a selected manufacturer.

6. The interactive user interface requisitioning tool and computerized ordering system of claim 5 wherein said interactive user interface component comprises a parts template library tool for enabling a user to select from or add to a pre-established library of parts to be used in the manufacture of the item.

7. The interactive user interface requisitioning tool and computerized ordering system of claim 5 wherein said interactive user interface component comprises a rules engine tool for checking and validating size and component specifications input by a user.

8. The interactive user interface requisitioning tool and computerized ordering system of claim 5 wherein said interactive user interface component comprises a job configuration tool for enabling a user to create, save, edit and/or release one or more manufacturing job orders.

9. The interactive user interface requisitioning tool and computerized ordering system of claim 5 wherein said interactive user interface component comprises a cable routing tool which automatically determines wiring routes in a cabinet/rack-mounted housing for electronic controller equipment.

10. The user interface and computerized ordering system of claim 5 wherein the requisition proposal information comprises at least a Bill of Materials.

11. The user interface and computerized ordering system of claim 5 wherein the requisition proposal information comprises a set of factory assembly drawings.

12. The user interface and computerized ordering system of claim 5 wherein the requisition proposal information comprises wiring cable routing documentation for a cabinet/rack-mounted housing for electronic controller equipment.

13. The user interface and computerized ordering system of claim 5 wherein one or more of said graphic display windows provides graphic tools enabling a user to specify components and size for a cabinet/rack-mounted housing for electronic controller equipment.

14. The user interface and computerized ordering system of claim 5 wherein said job order processing component comprises an application loader for loading and executing one or more application programs on said server in response to processing job order files received from a user computer, wherein said one or more application programs cause said server to generate drawings and documentation.

15. A computer implemented method for generating manufacturing requisition proposals and manufacturing documentation, the method comprising:
providing a plurality of interactive graphic windows on a user's computer display device, said graphic windows allowing a user to interactively select and input parameter information for developing a manufacturing requisition proposal for the manufacture of a particular item;
developing a data file comprising component selection information and manufacturing parameter information based upon the user's selection and input information; and
sending said data file to a server computer for further processing, wherein said server computer generates at least a bill of materials based on information in said data file.

16. The method of claim 15 wherein said step of developing a data file further comprises comparing said component selection information and parameter information with existing manufacturer design specifications and determining whether the particular item can be manufactured.

17. The method of claim 15 wherein said further processing by the server computer includes generating a set of engineering drawings.

18. The method of claim 15 wherein the particular item for which a manufacturing requisition proposal is developed is a cabinet/housing assembly for electronic equipment.

19. The method of claim 18 wherein said step of developing a data file further comprises determining a wiring cable routing and determining cable lengths.

20. The method of claim 15 wherein said plurality of interactive graphic windows provided on a user's computer display device comprise a plurality of menu selection graphics and input text boxes for developing a manufacturing requisition proposal for cabinet/rack-mounted housing and wiring arrangements for electronic controller equipment.

21. A computer readable medium having one or more computer-executable modules stored thereon, comprising:
an interactive user interface tools component that runs on a user's computer device and provides one or more interactive graphic display windows for enabling a user to configure a manufacturing job order by making selections from displayed icons or menu items and entering specific data in displayed text input boxes.

22. The computer readable medium of claim 21 wherein the interface tools component comprises a job configuration tool module.

23. The computer readable medium of claim 21 wherein the interface tools component comprises a rules engine for cabinet size validation tool module.

24. The computer readable medium of claim 21 wherein the interface tools component comprises a template parts library tool module.

25. The computer readable medium of claim 21 wherein the interface tools component comprises a cable routing computation tool module.

26. The computer readable medium of claim 21 wherein the interface tools component comprises a job configuration tool module.
